(19) United States
(12) Patent Application Publication
(10) Pub. No.: US 2008/0090559 A1
(43) Pub. Date: Apr. 17, 2008

(54) TIME-DEPENDENT INFORMATION MANAGEMENT SYSTEM AND METHOD FOR MOBILE PHONE

(75) Inventors: Jung Mi LEE, Goyang-si (KR); Byeong Cheol HWANG, Seoul (KR); Jin Young JEON, Seoul (KR); Young Mi KIM, Seoul (KR); Min Jeong KWON, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/833,020

(22) Filed: Aug. 2, 2007

(30) Foreign Application Priority Data
Oct. 17, 2006 (KR) 2006-0100987

(51) Int. Cl. H04Q 7/22

(52) U.S. Cl. 455/414.3

(57) ABSTRACT

A time-dependent information management system and method for a mobile phone that enable the management of time-related information in consideration of a change of time zone are provided. The method includes registering an event planned to occur at a first local time based on a first time zone together with a reference time calculated from the first local time; if the mobile phone enters into a second time zone, selecting the event in accordance with a key input; and setting the event to occur at a second local time calculated from the reference time. The system and method enable selectively adapting, when a mobile phone moves from a first time zone to a second time zone, times of schedules planned in the first time zone to a local time of second time zone, thereby effectively managing the schedules in multiple time zone-crossing environment.

### PRIORITY

This application claims priority to an application entitled “TIME-DEPENDENT INFORMATION MANAGEMENT SYSTEM AND METHOD FOR MOBILE PHONE” filed in the Korean Intellectual Property Office on Oct. 17, 2006 and assigned Serial No. 2006-0100987, the contents of which are hereby incorporated by reference.

### BACKGROUND OF THE INVENTION

1. Field of the Invention

The present invention relates to a mobile phone and, in particular, to a time-dependent information management system and method for a mobile phone that enable the managing of time-related information.

2. Description of the Related Art

Mobile phones are no longer just devices for voice communication but incorporate various additional functions such as an electronic messenger, calculator, ringtone management, scheduler, and alarm, and as technology develops more supplementary functions are likely to be integrated. The scheduler and alarm functions can be classified into a time management application.

However, the time management applications of the mobile phone may be worthless when a user moves across a time zone, since all the event times reserved for the schedules and alarms registered at a previous time zone are changed in accordance with a local time in a new time zone.

For example, if an event scheduled, when in the new time zone, for a certain schedule or alarm, does not occur when returning to the previous time zone, even it is valid in the previous time zone, the user may miss an important schedule or alarm. Accordingly, the user is required to reregister the same schedule and alarm in order to avoid missing schedules and alarms, resulting in burdensome manipulation and inconvenience.

### SUMMARY OF THE INVENTION

The present invention has been made in an effort to solve the above problems, and it is an object of the present invention to provide a time-dependent information management system and method for a mobile phone that are capable of effectively managing schedules and alarms across multiple time zones.

It is another object of the present invention to provide a time-dependent information management system and method for a mobile phone that are capable of selectively adapting the schedules and alarms to local times of different time zones.

In accordance with an aspect of the present invention, the above and other objects are accomplished by a time-dependent information management method for a mobile phone. The time-dependent information management method includes registering an event planned to occur at a first local time depending on a first time zone together with a reference time calculated from the first local time; selecting, if the mobile phone enters into a second time zone, the event in accordance with a key input; and setting the event to occur at a second local time calculated from the reference time.

In accordance with another aspect of the present invention, the above and other objects are accomplished by a time-dependent information management system for a mobile phone. The time-dependent information management system includes a memory unit for storing at least one event with a first local time at which the event is planned to occur in a first time zone and with a reference time calculated from the first local time; a display unit for displaying a list of events stored in the memory unit in accordance with a key input; and a control unit for calculating, if an event is selected from the list, a second local time dependent on a second time zone from the reference time and associating the second local time to the event.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a configuration of a mobile communication system for supporting a time-dependent information management system and method of a mobile phone according to an exemplary embodiment of the present invention;

FIG. 2 is a block diagram illustrating a configuration of a mobile phone employing the time-dependent information management system and method according to an exemplary embodiment of the present invention;

FIG. 3 is a flowchart illustrating a schedule registration procedure of a time-dependent information management method for a mobile phone according to an exemplary embodiment of the present invention;

FIGS. 4A to 4D are screen images illustrating steps of the schedule registration procedure of FIG. 3;

FIG. 5 is a flowchart for illustrating a schedule adaptation procedure of a time-dependent information management method for a mobile phone according to an exemplary embodiment of the present invention;

FIGS. 6A to 6E are screen images illustrating steps of the schedule adaptation procedure of FIG. 5;

FIG. 7 is a flowchart illustrating a schedule search procedure of a time-dependent information management method for a mobile phone according to an exemplary embodiment of the present invention; and

FIGS. 8A to 8D are screen images illustrating steps of the schedule search procedure.

### DETAILED DESCRIPTION OF PREFERRED EMBODIMENTS

Preferred embodiments of the present invention are described with reference to the accompanying drawings. The same reference numbers are used throughout the drawings to refer to the same or like parts. Detailed descriptions of well-known functions and structures incorporated herein are omitted to avoid obscuring the subject matter of the present invention.

The following definitions are provided to enable a clear and consistent understanding of the detailed description and the claims. Unless otherwise noted, terms are to be understood according to conventional usage by those skilled in the relevant art.

A “time zone” is a region of the Earth that has adopted the same standard time. Standard time zones can be defined by geometrically dividing the Earth's spheroid into 24 zones bordered by meridians each 15 degrees of longitude apart. Each time zone may be subdivided in accordance with an adoption of summer time (i.e. daylight savings time). A “first time zone” is a time zone in which specific schedules and alarms are registered to a mobile phone. In the following embodiments, the first time zone is represented by Seoul, Korea time as an example. A “second time zone” is a time zone to which the mobile phone moves. In the following embodiments, the second time zone is represented by Seattle, Wash. time as an example.

“Time zone information” is information used for recognizing a local time of the time zone in which the mobile phone is currently S located. The time zone information includes information on a longitude, local time, and summer time (i.e. daylight savings time) of a time zone.

“Time information” is information planned by a user, and includes schedules and alarms to be attended to. A “time of the first time zone” means a local time at which a schedule or alarm is registered in the first time zone, and a “time of the second time zone” means a local time of the second time zone corresponding to the time of the first time zone.

A “reference time” is Greenwich Mean Time (GMT).

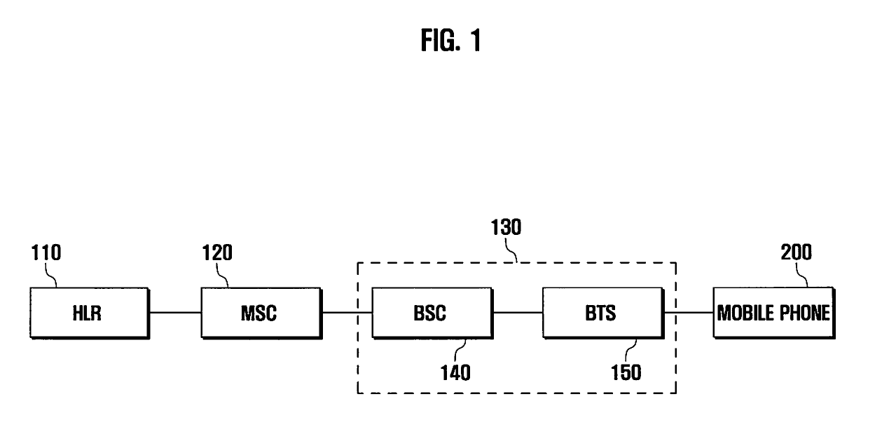

FIG. 1 is a block diagram illustrating a configuration of a mobile communication system for supporting time-dependent information management system and method of a mobile phone according to an exemplary embodiment of the present invention.

Referring to FIG. 1, the mobile communication network includes a Home Location Register (HLR) 110, a Mobile Switching Center (MSC) 120, a base station (BS) 130, and a mobile phone 200.

The HLR 110 is a register for storing information on the base stations. MSC 120 analyzes the information stored in the HLR 110 and monitors movement of the mobile phone 200 and manages exchanges of information between the BSs.

The BS 130 may include the BSC 140 and BTS 150. The BSC 140 receives time zone information from a Global Positioning System (GPS). The BTS 150 transmits the time zone information to the mobile phone 200 through a synchronization message.

The mobile phone 200 analyzes the time zone information received from the BS 130 and displays a time input by the user with reference to the time zone information.

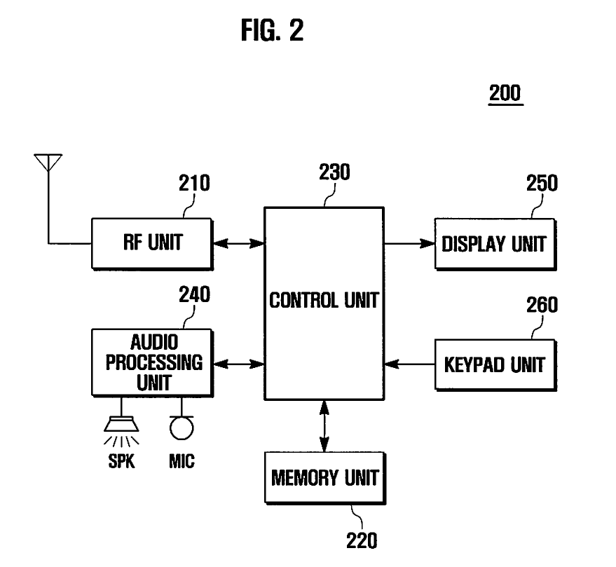

FIG. 2 is a block diagram illustrating a configuration of a mobile phone employing the time-dependent information management system and method according to an exemplary embodiment of the present invention.

Referring to FIG. 2, the mobile phone 200 includes a radio frequency (RF) unit 210, a memory unit 220, a control unit 230, an audio processing unit 240, a display unit 250, and a keypad unit 260.

The RF unit 210 is responsible for the radio communication. The RF unit 210 includes an RF transmitter for up-converting and amplifying a baseband signal to be transmitted and an RF receiver for low noise amplifying and down-converting a received radio signal. Particularly, the RF unit 210 receives the RF signal containing the time zone information in real time.

The memory unit 220 may include a program memory and a data memory. The program memory stores an operating system program and various application programs including a time management application program. The data memory stores application data generated while executing the application programs. Particularly, the memory unit 220 stores time information such as a time of the first time zone and the reference time calculated on the basis of the time of the first time zone.

The control unit 230 controls general operations of the mobile phone 200. The control unit 230 may include a data processing unit having a modulator for modulating the signal to be transmitted and a demodulator for demodulating the received signal. The data processing unit includes at least one modem and codec.

The control unit 230 analyzes the first time zone information received through the RF unit 210 and determines if daylight savings time is applied to the local time of the first time zone. In the case that daylight savings time is applied, the control unit 230 calculates a reference time based on the daylight savings time and stores the calculated reference time in the memory unit 220. The control unit 230 detects an entry into a second time zone and displays on the display unit 250 time information list stored in the memory unit 220 in accordance with a user command.

If time information of the first time zone is selected by the user, the control unit 230 calculates a time of the second time zone corresponding to the time information and displays the time information in association with the local time of the second time zone. The control unit 210 analyzes the second time zone information received through the RF unit 210 in real time and determines if daylight savings time is applied to the local time of the second time zone. If daylight savings time is applied to the local time of the second time zone, the control unit 230 displays the local time based on daylight savings time.

The audio processing unit 240 processes the audio signal output from an audio codec of the data processing unit to output the audio signal as an audible sound wave through a speaker (SPK), and processes the audio signal input through a microphone (MIC) to output the processed audio signal to the audio codec of the data processing unit.

The display unit 250 displays operation status of the mobile phone 200 under the control of the control unit 230. The display unit 250 can be implemented with a liquid crystal display (LCD). In this case, the display unit 250 may include a LCD controller, a dedicated memory, and LCD device. If the display unit 250 is implemented with an LCD having a touchscreen function, the display unit 250 can operate as an input device. According to the present invention, the display unit 250 displays a time selection screen listing the time information stored in the memory unit 220.

The keypad unit 260 is provided with a plurality of alphanumeric keys for inputting user data and various function keys for executing basic and supplementary functions of the mobile phone.

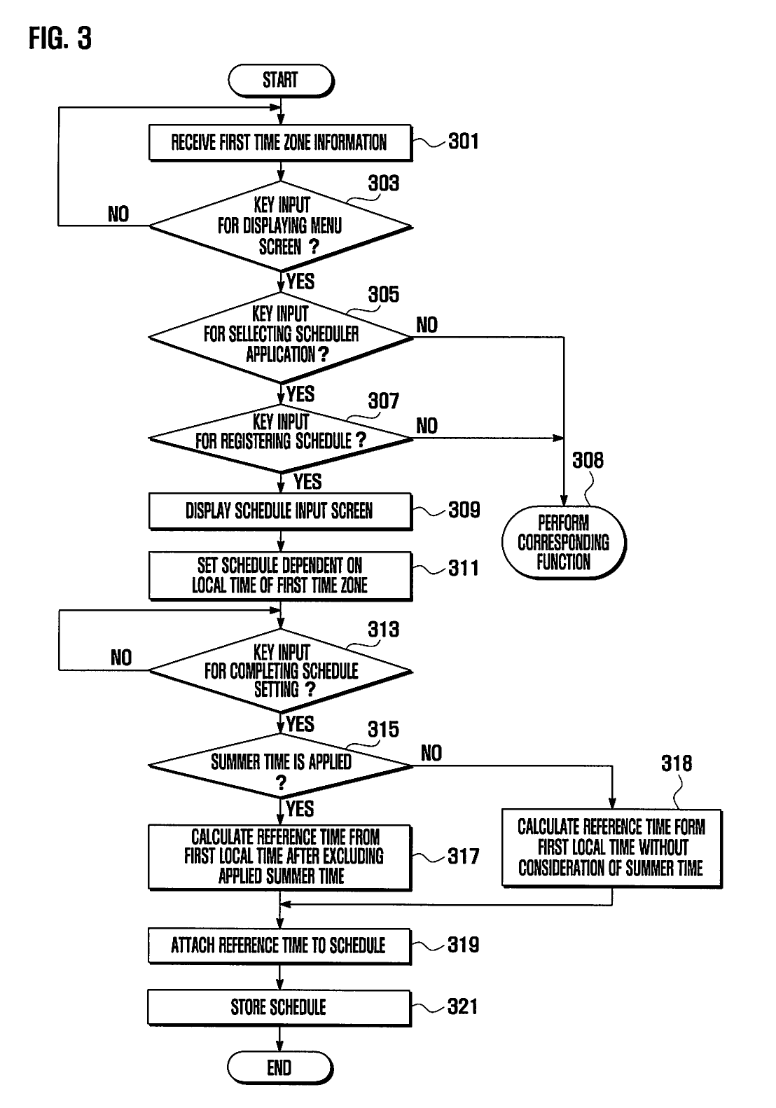

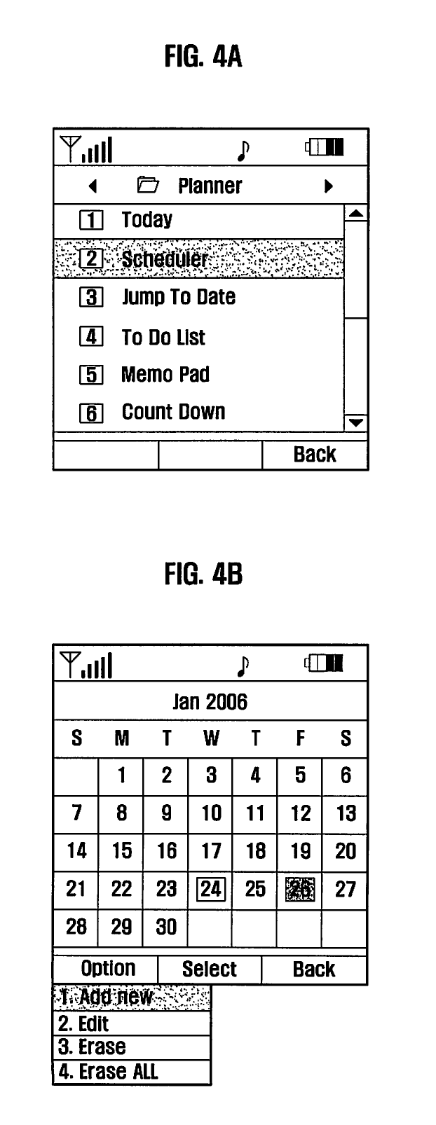

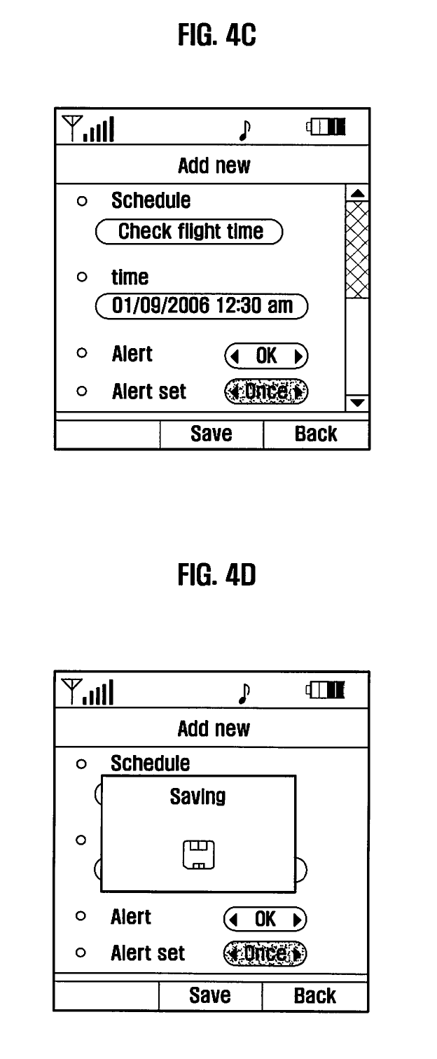

FIG. 3 is a flowchart illustrating a schedule registration procedure of a time-dependent information management method for a mobile phone according to an exemplary embodiment of the present invention, and FIGS. 4A to 4D are screen images illustrating steps of the schedule registration procedure of FIG. 3.

Referring to FIGS. 3 and 4A to 4D, the schedule registration procedure of the time-dependent information management method starts with receiving time information in a first time zone in step S301. In the first time zone, the mobile phone 200 determines if a key input for displaying a menu screen is detected in step S303. If a key input for displaying a menu screen is detected, the mobile phone 200 displays on the display unit 250 the menu screen in response to the key input, as shown in FIG. 4A, and determines if a key input for selecting a scheduler application among the application listed in the menu screen is detected in step S305.

If a key input for selecting a scheduler application is detected, the mobile phone 200 displays on the display unit 250 a calendar screen associated with the scheduler application together with a plurality of editing options as shown in FIG. 4B, and determines if a key input for registering a schedule is detected while the calendar screen is displayed in step S307.

If a key input for registering a schedule is detected, the mobile phone 200 displays a schedule input screen as shown in FIG. 4C in step S309.

Through the use of the schedule input screen, the mobile terminal allows the user to set a schedule dependent on the local time of the first time zone in step S311. Next, the mobile phone determines if a key input for completing setting of the schedule in step S313. If a key input for completing setting of the schedule, the mobile phone determines if daylight savings time is applied to the local time of the schedule dependent on the first time zone in step S315. For example, if a first local time “2006-1-9, AM 12:30” dependent on the first time zone is input, the mobile phone 200 determines whether the day 2006-1-9 of the local time is in a daylight savings time period of the first time zone.

If a daylight savings time is applied to the first local time, the mobile phone 200 calculates a reference time from the first local time of the first time zone after excluding the applied daylight savings time from the first local time in step S317. In contrast, if daylight savings time is not applied to the first local time, the mobile phone 200 calculates a reference time from the first local time of the first time zone without considering daylight savings time in step S318. For example, if the day 2006-1-9 of the local time input by the user is in daylight savings time of the first time zone, the mobile phone 200 calculates the reference time on the basis of a 1 hour delayed time, i.e. AM 1:30. On the other hand, if the day 2006-1-9 of the local time input by the user is out of daylight savings time of the first time zone, the mobile phone 200 calculates the reference time on the basis of the time AM 12:30.

In the case that no daylight savings time is applied, the reference time (in this embodiment, GMT) becomes 2006-1-9, PM 3:30.

After calculating the reference time, the mobile phone 230 attaches the reference time to the schedule in step S319 and then stores the schedule within the memory unit 220 in accordance with the user input command in step S321 as shown in FIG. 4D.

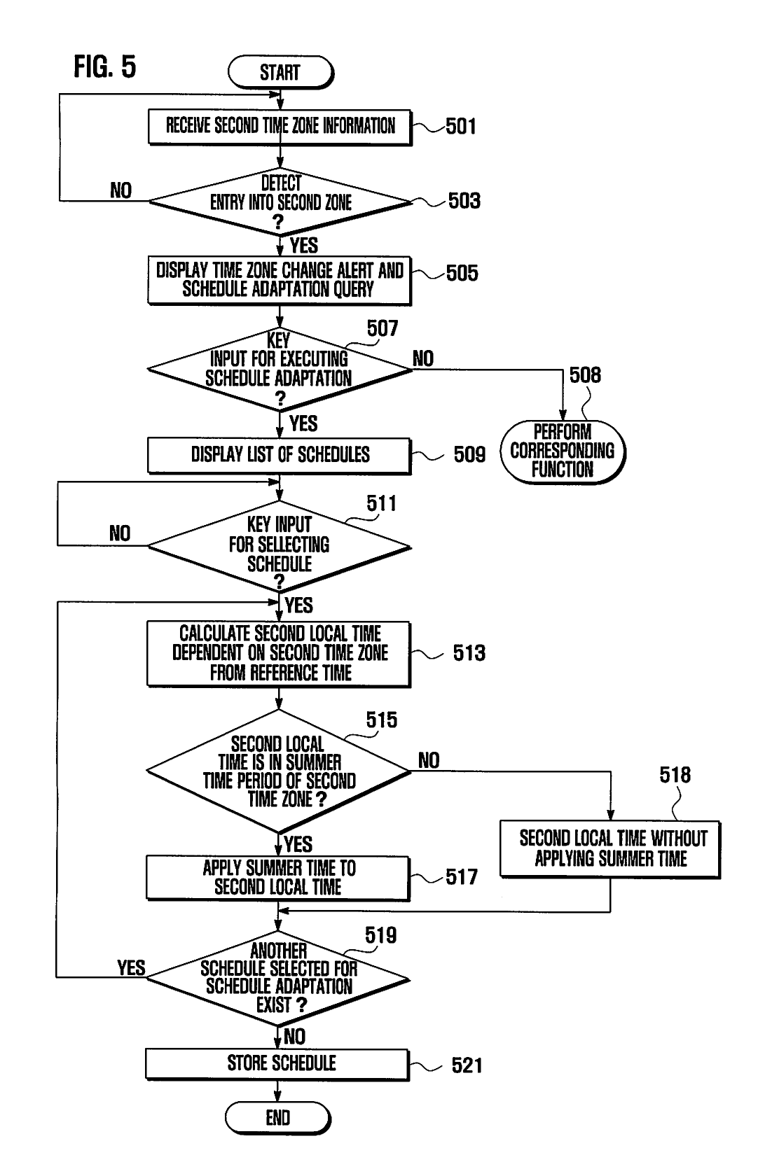

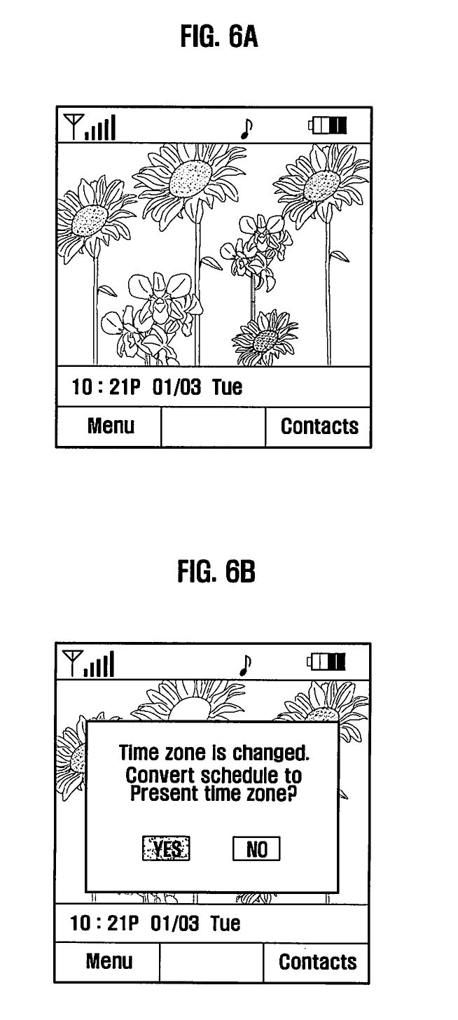

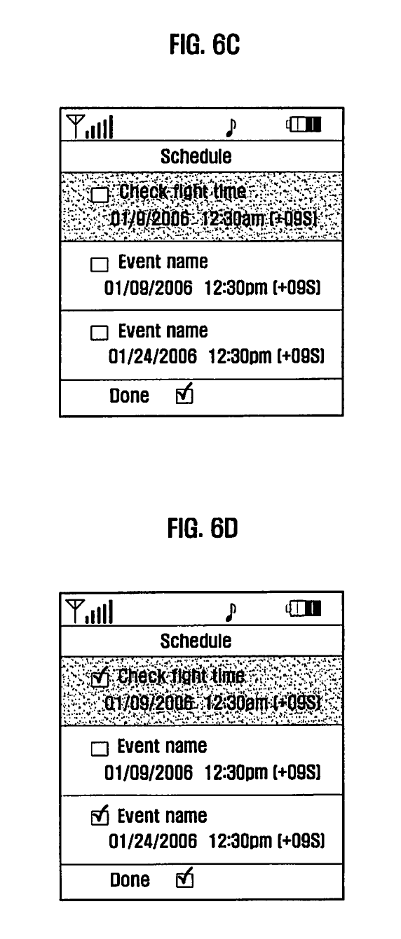

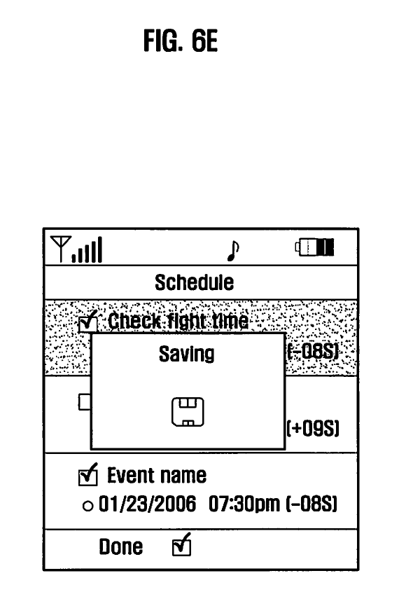

FIG. 5 is a flowchart for illustrating a schedule adaptation procedure of a time-dependent information management method for a mobile phone according to an exemplary embodiment of the present invention, and FIGS. 6A to 6E are screen images illustrating steps of the schedule adaptation procedure of FIG. 5.

Referring to FIGS. 5 and 6A to 6E, the schedule adaptation procedure starts with receiving time information from a second time zone in step S501. An exemplary display is shown in FIG. 6A. If the time information is received in the second time zone, the mobile phone 200 detects an entry of the mobile phone 200 into the second time zone in step S503. If the movement from the first time zone to the second time zone is detected, the mobile phone 200 displays on the display unit 250 a time zone change alert and a schedule adaptation query with yes/no buttons as shown in FIG. 6B in step S505.

If the yes button is selected, the mobile phone 200 determines if a key input for schedule adaptation is detected in step S507. If a key input for schedule adaptation is detected, the mobile phone 200 displays a schedule screen listing previously planned schedules as shown in FIG. 6C in step S509.

Next, the mobile phone 200 determines if at least one schedule is selected from the schedule screen in step S511 for allowing the user to check schedules that are adapted to the local time of the second time zone.

If at least one schedule is checked as shown in FIG. 6D, the mobile phone 200 determines a key input for executing the schedule adaptation in step S511. If the key input for executing the schedule adaptation, the mobile phone 200 calculates a second local time dependent on the second time zone from the reference time attached to the check schedule in step S513. For example, the mobile phone 200 calculates the local time of checked schedule in the second time zone from the reference time 2006-1-8, PM 3:30 of the checked schedule. Accordingly, the local time of the schedule becomes 2006-1-8, AM 7:30. Next, the mobile phone 200 determines if the local time of the schedule in the second time zone, i.e. the day 2006-1-8 of the planned schedule, is in the range of the daylight savings time in step S515.

If the second local time of the schedule is in daylight savings time of the second time zone, the mobile phone 200 applies daylight savings time to the second local time of the schedule in step S517. If the local time of the schedule is not in daylight savings time of the second time zone, the mobile phone 200 sets the local time calculated from the reference time as the second local time of the schedule dependent on the second time zone without applying daylight savings time in step S518.

For example, the mobile phone 200 sets the local time of the schedule to 2006-1-8, AM 6:30 which is 1 hour-advanced to the 2006-1-8, AM 7:30 if the day 2006-1-8 of the local time calculated from the reference time is in the daylight savings time period of the second time zone, and set to the local time 2006-1-8, AM 7:30 if the day 2006-1-8 of the local time calculated from the reference time.

Next, the mobile phone determines if another schedule selected for the schedule adaptation exists in step S519. If another schedule to be adapted to the local time of the second time zone, the mobile phone 200 repeats the steps S513 to S517. If no schedule to be adapted to the local time of the second time zone, the mobile phone 200 stores the schedule in the memory unit 220 together with the local time in the second time zone as shown in FIG. 6E in step S521.

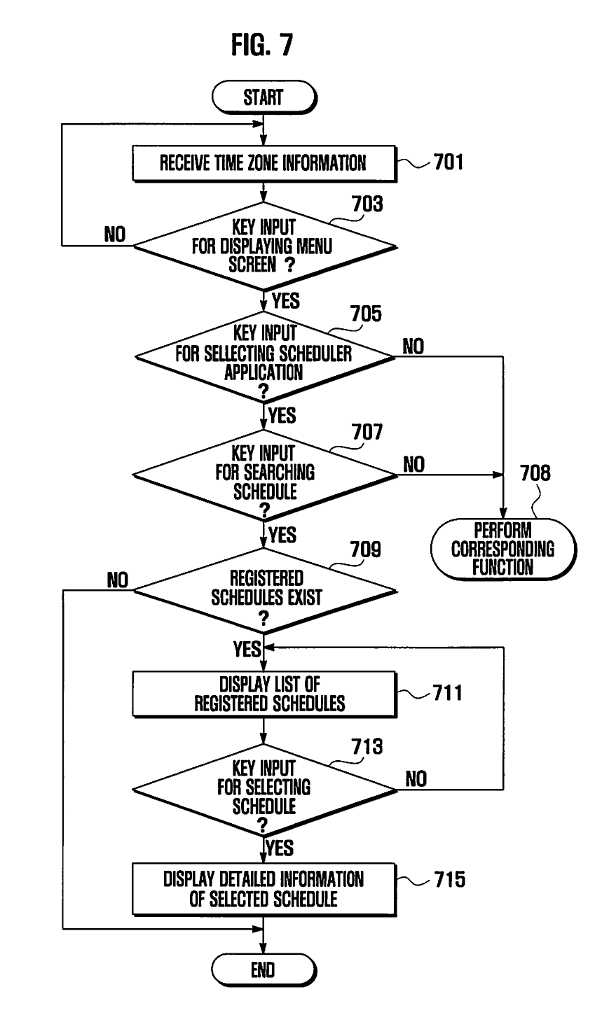

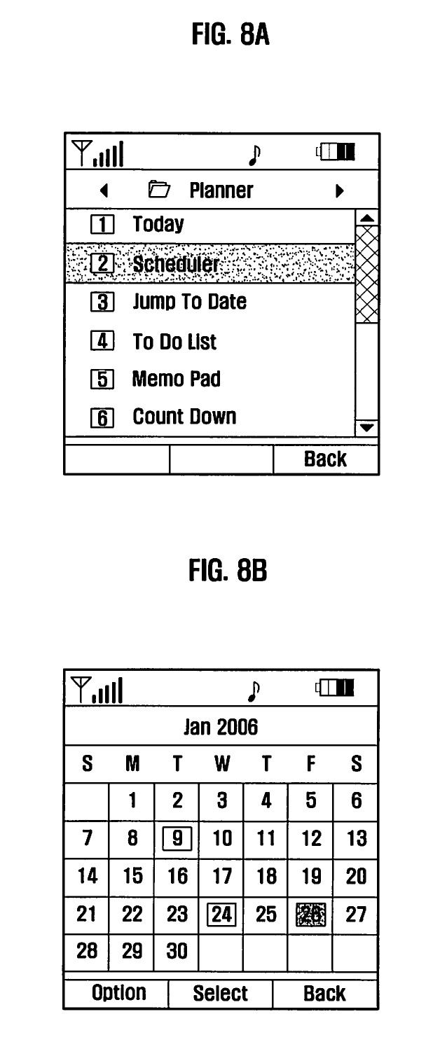

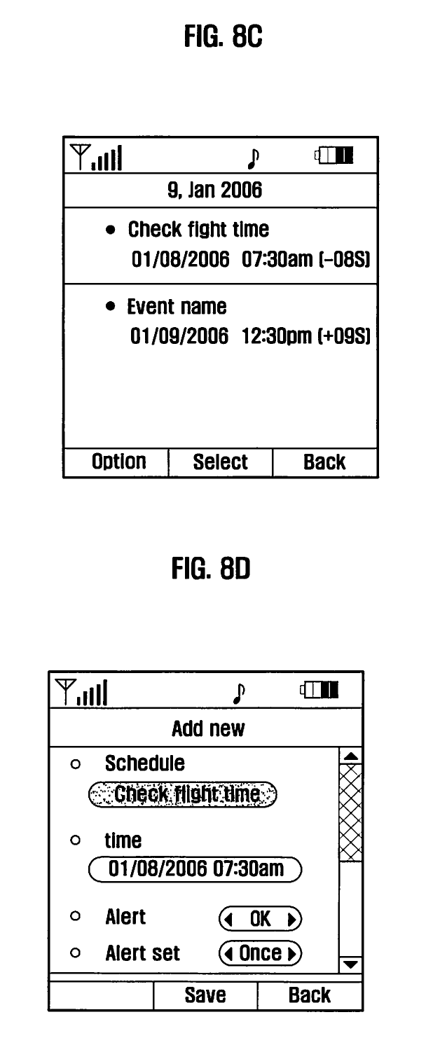

FIG. 7 is a flowchart illustrating a schedule search procedure of a time-dependent information management method for a mobile phone according to an exemplary embodiment of the present invention, and FIGS. 8A to 8D are screen images illustrating steps of the schedule search procedure.

Referring to FIGS. 7 and 8A to 8D, the schedule search procedure starts with receiving time zone information in the current time zone in step S701.

If the time zone information is received, the mobile phone 200 determines if a key input for displaying a menu screen is detected in step S703. If a key input for displaying a menu screen is detected, the mobile phone 200 displays on the display unit 250 the menu screen in response to the key input, as shown in FIG. 8A, and determines whether a key input for selecting a scheduler application among the application listed in the menu screen is detected in step S705.

If a key input for selecting a schedule application is detected, the mobile phone 200 displays on the display unit 250 a month calendar screen indicating days having planned schedules and schedule editing menus as shown in FIG. 8B, and determines if a key input for searching a schedule, i.e. for selecting a day in the month, is detected in step S707. If a key input for searching a schedule is detected, the mobile phone determines if at least one schedule is registered to the selected day in step S709. If at least one schedule exists that is registered to the selected day, the mobile phone 200 displays on the display unit 250 the schedule registered to the day as shown in FIG. 8C in step S711. At this time, a schedule can be displayed together with time zone information associated with the schedule. For example, if the time zone associated with a schedule is Seattle, Wash., the mobile phone can displays the schedule with the time difference between the reference time zone and the Seattle time zone (−8 hours GMT) and whether the current time is in daylight savings time (S).

Next, the mobile phone 200 determines if a key input for selecting a schedule registered to the day is detected in step S713 while the schedule is displayed on the display unit 250. If a key input for selecting a schedule is detected, the mobile phone 200 displays detailed information of the selected schedule as shown in FIG. 8D in step S715.

In the above embodiment, the time-dependent information management system is explained with a selective change of time of a schedule in accordance with a transition between two time zones. However, the present invention is not limited to the schedule. For example, the time-dependent information management system can be adopted to other time-based application data such as an alarm.

Although the time-dependent information management system and method are described in the case that the mobile phone moves from the first time zone to the second time zone in the above embodiment, the time-dependent information management system and method can be adopted when the mobile phone passes at least one intermediate time zone between the first and second time zones. For example, the schedule which is not adapted to the local time of an intermediate time zone while the mobile phone moves to the intermediate time zone, the schedule can be adapted to the local time of the second time zone in relation with the local time of the first time zone. In a case that the time of the schedule is adapted to a local time of the intermediate time zone, the time of the schedule changed in the intermediate time zone can be adapted to the local time of the second time zone again. This is because the time adaptation is performed on the basis of the reference time.

As described above, the time-dependent information management system and method of the present invention enable selectively adapting, when a mobile phone moves from a first time zone to a second time zone, times of schedules planned in the first time zone to a local time of second time zone, thereby effectively managing the schedules in multiple time zone-crossing environments.

Although exemplary embodiments of the present invention are described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A time-dependent information management method for a mobile phone, comprising:
registering an event planned to occur at a first local time based on a first time zone together with a reference time calculated from the first local time;
if the mobile phone enters into a second time zone, selecting the event in accordance with a key input; and
setting the event to occur at a second local time calculated from the reference time.

2. The time-dependent information management method of claim 1, wherein the registering step comprises:
determining if the first local time is in a daylight savings time period of the first time zone;
if the first local time is not in a daylight savings time period of the first time zone, calculating the reference time without considering daylight savings time;
if the first local time is in a daylight savings time period of the first time zone, calculating the reference time to be one hour advanced; and
associating the first local time to the event;

3. The time-dependent information management method of claim 1, wherein the selecting step comprises:
displaying a list of events registered in the first time zone; and
opening the event selected in accordance with a key input in an editing mode.

4. The time-dependent information management method of claim 1, wherein the setting step comprises:
calculating the second local time dependent on the second time zone;
determining if a day of the second local time is in a daylight savings time of the second time zone;
if a day of the second local time is in daylight savings time of the second time zone, applying the daylight savings time to the second local time; and
associating the second local time to the event.

5. The time-dependent information management method of claim 1, wherein the reference time is Greenwich Mean Time (GMT).

6. A time-dependent information management system for a mobile phone, comprising:
a memory unit for storing at least one event with a first local time at which the event is planned to occur in a first time zone and with a reference time calculated from the first local time;
a display unit for displaying, if the mobile phone enters into a second time zone, a list of events stored in the memory unit in accordance with a key input; and
a control unit for calculating, if an event is selected from the list, a second local time based on the second time zone from the reference time and associating the second local time to the event.

7. The time-dependent information management system of claim 6, further comprising a radio frequency unit for receiving time zone information in real time in a time zone where the mobile phone is located.

8. The time-dependent information management system of claim 7, wherein the control unit analyzes the time zone information in real time, determines whether the first local time is in a daylight savings time of the first time zone on the basis of an analysis result, and calculates, if the first time is in daylight savings time, the reference time after subtracting daylight savings time from first local time.

9. The time-dependent information management system of claim 7, wherein the control unit analyzes the time zone information, determines if the second local time is in daylight savings time of the second time zone on the basis of an analysis result, and calculates, if the second local time is in daylight savings time, the second local time by applying daylight savings time.

10. The time-dependent information management system of claim 6, wherein the reference time is Greenwich Mean Time (GMT).
